(19) United States
(12) Patent Application Publication
(10) Pub. No.: US 2006/0199576 A1
(43) Pub. Date: Sep. 7, 2006

(54) Signal superposing systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 11/287,352

(22) Filed: Nov. 28, 2005

Related U.S. Application Data
(60) Provisional application No. 60/658,966, filed on Mar. 7, 2005.

(51) Int. Cl. H04Q 7/38

(52) U.S. Cl. 455/418; 455/414.1

(57) ABSTRACT

The present invention generally relates to signal superposing systems, communication devices with such systems, and methods therefor. More particularly, the present invention relates to various signal superposing systems capable of generating outgoing signals through superposing background signals onto input signals from an user of the system in real time. Thus, the user may transmit such superposed signals to a third party while giving an impression that the user is currently in a situation represented by such background signals. The present invention also relates to various methods of generating the outgoing signals by superposing the background signal onto the input signal, methods of replacing noise signals in the outgoing signals by the background signals, and so on. The present invention also relates to various processes of providing such signal superposing systems, various processes of providing communication devices incorporating such systems, and so on.

The present application claims a benefit of an earlier filing date of a U.S. Provisional Application entitled, “Signal Superposing Systems and Methods,” filed on Mar. 7, 2005 by the same Applicant, and bearing a U.S. Ser. No. 60/658,966, an entire portion of which is incorporated herein by reference.

### FIELD OF THE INVENTION

The present invention generally relates to various signal superposing systems, communication devices including such systems, communication network utilizing such systems, various methods for each of the systems, devices, and network, and various processes for making the systems, devices, and network. More particularly, the present invention relates to various signal superposing systems capable of generating outgoing signals through superposing background signals selected by an user of the system onto input signals generated by such an user of the system in real time. Therefore, the user may transmit the superposed signals to a third party and giving him or her an impression that the user is currently in a situation represented by such background signals. The present invention relates to various communication devices incorporating such signal superposing systems therein as well as to various communication network utilizing such signal superposing systems. The present invention also relates to various methods of generating such outgoing signals by superposing the background signals onto the input signals, various methods of replacing noise signals contained in such outgoing signals with the background signals, various methods of communicating with the third party using the above communication device including such a signal superposing system, various methods of using a communication network using such systems. The present invention also relates to various processes of making such signal superposing systems, various processes of providing communication devices incorporating such systems, and various processes of constructing the communication network using such devices and systems.

### BACKGROUND OF THE INVENTION

Various communication devices have been in use. Original telephones had sent and received electric signals through wire. Various functions such as answering features and caller identifications had been added to such phones thereafter but all phones still required wire for communication. Only in the 1980's, cordless phones have then been introduced with a handset which did not require wire between itself and its base unit and emancipated the users from the telephone wire of a finite length. Video phones had also been introduced to the market, only to be rejected by consumers for failing to protect their privacy.

With the advent of mobile or wireless communication technology, mobile (also commonly called cellular or wireless) phones have become popular since early 90's. Features have been added to the mobile phones so that the users may enjoy call identification, voice mail, call waiting, call blocking, call forwarding, and others. Mobile (or wireless) internet then widened applications of the mobile phones by allowing the users to send and receive e-mails and to surf the internet therewith. In addition, such mobile phones are equipped with image acquiring devices and allow the users to capture static and dynamic images and to send and receive video signals thereof. Unlike the previous video phones, the mobile phones with the image acquiring devices have been favorably received by the market and it is therefore expected that such phones will be equipped with more powerful processors and eventually function as mobile video phones.

Although these mobile phones offer numerous advantages, such phones still operate with a century-old algorithm, i.e., receiving incoming signals in real time and sending outgoing signals in real time as well. Thus, the users may not be able to alter backgrounds signals during communication and do not have any choice other than exposing their privacy to third parties on the other side of the line.

Accordingly, there is a need for a signal processing system which may allow the user to vary or add background signals of his or her communication. Similarly, there is a need for a communication device, whether it may be wireless or wired, which allows the user to change background signals to his or her outgoing signals.

### SUMMARY OF THE INVENTION

The present invention generally relates to various signal superposing systems, communication devices including such systems, and communication network using such systems and devices. More particularly, the present invention relates to various signal superposing systems capable of generating an outgoing signal by superposing a background signal selected by an user onto an input signal which is also generated by the user in real time. Therefore, the user may transmit the superposed signal to a third party while giving the party an impression that the user is currently involved in a specific situation connoted by such background signal. The present invention relates to various communication devices which may incorporate such a signal superposing system and, accordingly, generate and transmit the outgoing signal which is obtained by superposing the background signal onto the input signal, where such communication devices may utilize wire and/or wireless network to transmit the outgoing signal. The present invention further relates to various communication networks which may utilize the above signal superposing systems and/or communication devices and which may enable the user to select a desired background signal from a library of background signals. Such communication networks may superpose the selected background signal onto the input signal before transmitting the outgoing signal or, in the alternative, may also transmit the selected background signal and the input signal separately to the third party.

The present invention relates to various methods of superposing the background signal onto the input signal in real time, various methods of communicating with the third party while superposing the background signal onto the input signal, various methods of providing various background signals to the user through the communication network, various methods of transmitting the output signal after such superposing, and various methods of transmitting the background and input signals separately to the third party. More particularly, the present invention relates to various methods of generating such an outgoing signal by superposing such a background signal onto the input signal in real time, various methods of replacing noise signals contained in the input and/or outgoing signals with the background signals, various methods of communicating with the third party using the above communication device including the above signal superposing system, various methods of transmitting the background, input, and/or outgoing signals in various modes via the communication network.

The present invention also relates to various processes for providing such signal superposing systems and various members and/or units thereof, various processes for incorporating the members and/or units of such systems into stationary or mobile communication devices such as mobile phones and PDA's, various processes for establishing a communication network between a communication provider and at least one communication device with such signal superposing systems, and various processes for distributing various members and/or units of such systems into both of such a provider and device.

Therefore, one objective of the present invention is to provide a signal superposing system for acquiring and storing multiple background signals and, thereafter, retrieve and superpose at least one background signal onto an input signal supplied thereto by the user in real time, thereby generating a compound signal. Therefore, such a compound signal may be used to imply that the user generating the input signal is in a specific circumstance represented by the retrieved background signal.

Another objective of the present invention is to fabricate the signal superposing system for a portable communication device, where an user may acquire and store multiple background signals in the system (or device) and, thereafter, retrieve and superpose at least one background signal onto an input signal generated by the user in real time. Therefore, a third party situated on an opposite end of a communication network may get an impression that the user is involved with an event connoted by such background signals and/or is in a location connoted thereby.

Another objective of the present invention is to provide the signal superposing system capable of acquiring the background signals from various routes. For example, such a system may include an input unit for acquiring audio and/or visual signals of an user of the system, of another person and/or object, and so on. The system may include another input unit for retrieving audio and/or visual signals stored in various media such as, e.g., magnetic tapes, CDs, DVDs, and the like. The system may also be arranged to acquire audio and/or visual signals through internet.

Another objective of the present invention is to superpose a shorter background signal stored in portable communication device onto a longer input signal supplied thereto by an user. Accordingly, the shorter signal may be repeatedly superposed onto the longer input signal, multiple shorter signals may be superposed thereonto in a preset order (and repeatedly when necessary), multiple shorter signals may be superposed thereonto in a series of different orders, and the like.

Another objective of the present invention is to provide a signal superposing system suitable for a mobile communication device, where the user may acquire various audio and/or visual signals by various audio and/or video input units of the device. Thereafter, the user may store and retrieve one or more of such signals and use such as the background signals which may be superposed onto the input signal from the user.

Another objective of the present invention is to provide such a signal superposing system for the portable communication device, where the user may adjust an amplitude of the background signal with respect to the input signal while superposing the background signal onto the input signal. Thus, the amplitude of the background signal may be maintained at a preset level and/or a preset ratio with respect to an amplitude of the input signal.

Another objective of the present invention is to provide mobile and/or stationary communication devices incorporating therein such a signal superposing system which may in turn include at least one switch and, therefore, which are easy to operate. For example, such a system includes at least one switch for initiating and terminating a signal superposing process, and the device exposes the switch in order to allow the user to readily manipulate such a switch. In another example, such a switch may allow the user to simply retrieve the desired background signal by moving or otherwise manipulating such a switch.

Another objective of the present invention is to provide a communication network comprised of a communication provider and at least one communication device, where such a signal superposing system is incorporated solely into the communication device, solely into the communication provider or into both of the communication provider and communication device. By incorporating at least a portion of the signal superposing system into the provider, a weight and volume of the communication device may be reduced.

Another objective of the present invention is to utilize the above communication network and to acquire in real time various background signals such as, e.g., a background signal of an event which is happening in real time and in which the user is not involved, another background signal originating in real time in a location in which the user is not situated, and the like. Accordingly, the compound signal obtained by superposing such background signals onto the input signal in real time is likely to be more realistic than other background signals prerecorded and then stored in advance in the communication device and/or provider.

Another objective of the present invention is to provide the communication network including a variety of external input units installed in various physical locations, acquiring different background signals in each of such locations, and superposing one or more of such signals onto the input signal in a preset pattern. Accordingly, such background signals may simulate movement of the user from one location toward another.

Another objective of the present invention is to provide the communication device incorporating the above signal superposing system, where the user may monitor the outgoing signal and adjust the amplitude and/or other features of the background signal according to his or her needs. This feature may allow the user to simulate real sounds associated with the preset event and/or location far more accurately than simply playing the background signal at a preset amplitude and/or pattern.

Various signal superposing systems and devices incorporating such systems offer numerous advantages. First of all, users may select various background signals in such systems and add such signals as a background when they communicate with the third party. Therefore, the users may add music or other music-related signals to the outgoing signals as the background during communication such that the third party may listen to the user's signals with such music. Secondly, such users may replace the background with one of their choice. For example, the users may select the background signal reflecting a concert, a meeting, a traffic jam, a bar, a construction site, a nursery, and the like. By including such a background signal in such an outgoing signal, the users may give the third party an impression that the users are currently in the concert or meeting, caught in the traffic jam, drinking in the bar, visiting or working in the construction site, nursing babies, and the like. Thirdly, such users may enhance signal-to-noise ratios of their outgoing signals by separating content signals from noise signals of their input signals, filtering out or attenuating the noise signals, and adding new background signal.

Various signal superposing systems of the present invention may be incorporated into almost any kinds of conventional communication devices. For example, such systems may be incorporated into a mobile or wireless telephone, a cordless telephone with a handset and a base set, a telephone receiving and sending signals through wire, and the like. In addition, such systems may be used with portable palm devices such as palm pilots, laptop computers, desktop computers, and other devices capable of providing wire and/or wireless communication with the third party through voices, images or texts.

In one aspect of the present invention, various signal superposing communication systems are provided to receive and transmit signals.

In one exemplary embodiment of such an aspect of the present invention, a signal superposing communication system may include at least one transmitting member and at least one control member. The transmitting member may receive an input signal generated by an user and transmit an outgoing signal. The control member may store multiple background signals therein, receive at least one user command, retrieve at least one of the above background signals according to the command, generate a compound signal by superposing the retrieved signal over the input signal in real time, and send the compound signal to the transmitting member which may generate the outgoing signal at least in part from the compound signal.

In another exemplary embodiment of this aspect of the present invention, a signal superposing communication system may include at least one transmitting member and at least one control member. Such a transmitting member may be arranged to receive an input signal generated by an user and to transmit an outgoing signal. The control member may include therein at least one memory unit, at least one control unit, and at least one processing unit. Such a memory unit may store multiple background signals, the control unit may receive at least one user command and retrieve at least one of the above background signals from the memory unit according to the command, while the processing unit may receive the input signal and retrieved signal, generate a compound signal by superposing the retrieved signal over the input signal in real time in a preset mode determined by the user command, and send the compound signal to the transmitting member which may generate such an outgoing signal at least in part from the compound signal. The processing unit may perform further functions. In one example, such a unit may manipulate an amplitude of the retrieved signal during the above superposing based upon the mode. In another example, such a unit may control a ratio of an amplitude of the retrieved signal to that of the input signal during the superposing based on the mode. In another example, the processing unit may control an amplitude of the retrieved signal in a preset temporal pattern during the superposing based on the preset mode. In another example, the processing unit may manipulate an amplitude of the retrieved signal in the superposing adaptively with respect to an amplitude of the input signal based upon the preset mode.

In another aspect of the present invention, a signal superposing system may be provided for a communication device having a transmitting member which may be arranged to receive an input signal generated by an user and to transmit an outgoing signal, where at least a portion of the system may be incorporated into the device.

In one exemplary embodiment of such an aspect of the present invention, a signal superposing system may include a control member which may store multiple background signals therein, receive at least one user command, retrieve at least one of such background signals based upon the command, generate a compound signal by superposing the retrieved signal over the input signal in real time, and send the compound signal to the transmitting member which may generate the outgoing signal at least in part from the compound signal.

In another exemplary embodiment of this aspect of the present invention, a signal superposing system may include a control member which may in turn include at least one memory unit, at least one control unit, and at least one processing unit. The memory unit may store multiple background signals, and the control unit may receive at least one user command and retrieve from the memory unit at least one of the background signals based upon the command. The signal processing unit may receive the input signal and retrieved signal, generate a compound signal by superposing the retrieved signal over the input signal in real time in a preset mode based upon the user command, and send the compound signal to the transmitting member which may generate the outgoing signal at least in part from such a compound signal. The processing unit may perform further functions. In one example, the processing unit may manipulate an amplitude of the retrieved signal in the superposing based upon the mode. In another example, such a unit may control a ratio of an amplitude of the retrieved signal to that of the input signal during the superposing based upon the mode. In another example, such a unit may control an amplitude of the retrieved signal in a preset temporal pattern during the superposing based on the preset mode. In another example, the unit may manipulate an amplitude of the retrieved signal in the superposing adaptively with respect to an amplitude of the input signal based on the preset mode.

In another aspect of the present invention, a signal superposing system may be provided for a communication device which may include a receiving member capable of receiving an incoming signal and a transmitting member capable of receiving an input signal generated by an user and transmitting an outgoing signal, where at least a portion of the system may be incorporated into the device.

In one exemplary embodiment of such an aspect of the present invention, a signal superposing system may have at least one memory unit, at least one control unit, and at least one processing unit. The memory unit may store multiple background signals, while the control unit may receive at least one user command and retrieve from the memory unit at least one of the above background signals based upon the user command. The processing unit may generate a compound signal by superposing the retrieved signal over the input signal in real time and send such a compound signal to the transmitting member which may then generate the outgoing signal at least in part from the compound signal.

In another exemplary embodiment of this aspect of the present invention, a signal superposing system may have at least one memory unit, at least one control unit, and at least one processing unit. The memory unit may store multiple background signals, while the control unit may receive at least one user command and retrieve from the memory unit at least one of such background signals based upon the command. The processing unit may generate a compound signal by superposing the retrieved signal over the input signal in real time in a preset mode based upon the user command, and send the compound signal to the transmitting member which may generate the outgoing signal at least in part from the compound signal. The processing unit may perform further functions. In one example, such a unit may manipulate an amplitude of the retrieved signal during the superposing based on the mode. In another example, such a unit may control a ratio of an amplitude of the retrieved signal to that of the input signal during the superposing based on the mode. In another example, the unit may control an amplitude of the retrieved signal in a preset temporal pattern during the superposing based upon the preset mode. In another example, the unit may manipulate an amplitude of the retrieved signal during the superposing adaptively with respect to an amplitude of the input signal based on the preset mode.

In another exemplary embodiment of this aspect of the present invention, a signal superposing system may have at least one memory unit, at least one control unit, and at least one processing unit. The memory unit may store multiple background signals each of which may last for a preset length of time, and the control unit may receive at least one user command and then retrieve at least one of the above background signals from the memory unit based upon the user command. In one example, the processing unit may generate a compound signal by superposing the retrieved signal onto the input signal in real time and continue the superposing repeatedly until the input signal which is longer than the preset length stops, while sending such a compound signal to the transmitting member which may generate the outgoing signal at least in part from the compound signal. In another example, such a unit may also generate a compound signal by superposing such at least two of the retrieved background signals in a preset order over the input signal in real time and then continue the above superposing in the preset order repeatedly until the input signal which is longer than a sum of the preset lengths of such at least two of the retrieved signals may terminate, while sending such a compound signal to the transmitting member which may generate the outgoing signal at least in part from the above compound signal. In another example, the processing unit may generate a compound signal by superposing such at least two of the retrieved background signals in a preset order over the input signal in real time and continue such superposing in a different order repeatedly until the input signal which is longer than a sum of the preset lengths of such at least two of the retrieved signals may terminate, while sending such a compound signal to the transmitting member which may generate the outgoing signal at least in part from the compound signal.

In another aspect of the present invention, a communication system may be provided so as to superpose various signals one over the other.

In one exemplary embodiment of this aspect of the present invention, a communication system may have at least one transmitting member and at least one control member. The transmitting member may receive an input signal from an user, whereas the control member may store multiple background signals, receive at least one user command, and retrieve at least one of the background signals based on the user command. The transmitting member may also transmit the retrieved signal along with such an input signal in real time.

In another exemplary embodiment of such an aspect of the present invention, a communication system may have at least one transmitting member and at least one control member. The transmitting member may receive an input signal provided by an user, and the control member may have therein at least one memory unit and at least one control unit. The memory unit may store multiple background signals therein, while the control unit may receive at least one user command and retrieve at least one of such background signals from the memory unit based upon the user command. Such a transmitting member may transmit the retrieved and input signals in real time while, e.g., manipulating an amplitude of the retrieved signal during the superposing based on the mode, controlling a ratio of an amplitude of the retrieved signal to that of the input signal during the superposing based on the mode, controlling an amplitude of the retrieved signal in the superposing in a preset temporal pattern based upon the preset mode, and/or manipulating an amplitude of the retrieved signal during the superposing adaptively with respect to or in proportion to an amplitude of the input signal based upon the preset mode.

In another aspect of the present invention, a signal superposing system may be provided for a communication device including therein at least one transmitting member which may receive an input signal generated by an user and transmit an outgoing signal.

In one exemplary embodiment of such an aspect of the present invention, a signal superposing system may include at least one control member which may store multiple background signals therein, receive at least one user command, and retrieve at least one of the background signals based on the user command. The transmitting member may transmit the retrieved signal along with the input signal in real time.

In another exemplary embodiment of this aspect of the present invention, a signal superposing system may include at least one control member which may have therein at least one memory unit and at least one control unit. The memory unit may store multiple background signals therein, whereas the control unit may receive at least one user command and retrieve at least one of the above background signals from the memory unit based on the user command. The transmitting member may transmit the retrieved signal along with the input signal in real time, while manipulating an amplitude of the retrieved signal during the superposing based upon the mode, controlling a ratio of an amplitude of the retrieved signal to that of the input signal during the superposing based on the mode, controlling an amplitude of the retrieved signal during the superposing in a preset temporal pattern based upon the preset mode, and/or manipulating an amplitude of the retrieved signal during the above superposing adaptively with respect to or in proportion to an amplitude of the input signal based upon the preset mode.

In another aspect of the present invention, a mobile telecommunication system may further be provided for superposing various signals one over the other.

In one exemplary embodiment of this aspect of the present invention, a mobile communication system may include at least one transmitting member, at least one control member, a body, and at least one switch. The transmitting member may receive an input signal generated by an user and transmit an outgoing signal to a provider of the communication, whereas the control member may store multiple background signals, receive at least one user command, also retrieve at least one of the background signals based on the command, generate a compound signal by superposing the retrieved signal over the input signal in real time, and send the compound signal to the transmitting member which generates the outgoing signal at least in part from the compound signal and transmits such an outgoing signal to the provider. The body may enclose at least a portion of each of the members, and at least a portion of such a switch may be exposed through the body. In one example, the switch may initiate and stop such superposing of the transmitting member. In another example, the switch may enable the user to select the retrieved signal from multiple background signals.

In another exemplary embodiment of such an aspect of this invention, a mobile communication system may have at least one transmitting member and at least one control member. The transmitting member may receive an input signal from an user and then transmit an outgoing signal to a provider of the communication. The control member may include therein at least one memory unit, control unit, and processing unit. The memory unit may store multiple background signals therein, while the control unit may receive at least one user command and retrieve at least one of the background signals from the memory unit based upon the command. The processing unit may receive the input signal and retrieved signal, to generate a compound signal by superposing the retrieved signal over the input signal in real time in a preset mode which is determined by the user command, and send such a compound signal to the transmitting member which may generate the outgoing signal at least in part such a the compound signal and transmit the outgoing signal to such a provider. The processing unit may perform further functions. In one example, such a unit may manipulate an amplitude of the retrieved signal during the superposing based on the mode. In another example, such a unit may control a ratio of an amplitude of the retrieved signal to that of the input signal during the superposing based on the mode. In another example, the unit may control an amplitude of the retrieved signal in a preset temporal pattern during the superposing based on the preset mode. In another example, the unit may manipulate an amplitude of the retrieved signal during the above superposing adaptively with respect to or in proportion to an amplitude of the input signal based upon the preset mode. In each of such examples, the system may also include a body and at least one switch, where the body mat enclose at least a portion each of of the members, and at least a portion of the switch may be exposed through the body. In one example, the switch may initiate and stop the superposing by the processing member. In another example, the switch may enable the user to select the retrieved signal from multiple background signals.

Embodiments of the foregoing aspects of various systems of the present invention may further include one or more of the following features.

The system may be incorporated into a communication device which may be either stationary or portable (e.g., a mobile phone, a cordless handset and/or a base of a phone, a conventional wired phone, and so on), a music playing device (e.g., a tape player, a CD player, an MP3 player, and so on, each of which may be a stationary or portable device), and the like. At least one of the receiving and transmitting members may be incorporated as a member of the system or one of such devices. Such a system and/or device may transmit the outgoing signal through wire or wirelessly, where such wire may transmit the outgoing signal electrically, optically, and/or magnetically. At least one of the signals may be an audio signal, video signal, and/or audiovisual signal. At least one of such members and/or their units may also receive, store, process, and/or transmit only audio signals, only video signals or audiovisual signals.

The background signal may be one of the incoming, input, and/or outgoing signals recorded in real time by the user, one of the incoming, input, and/or outgoing signals prerecorded by the user, a signal provided by a manufacturer of the system, a signal provided through another electric device, and the like. At least one of the background signals may be provided to such a system by an external storage device examples of which may be a diskette, CD, DVD, microchip, and other storage articles capable of storing therein analog and/or digital signals. At least one of the background signals may be a noise signal. At least one of the background signals may be provided to the system through at least one of the receiving and transmitting members. At least two of the background signals may also last for different lengths of time. At least one of such background signals may be provided by mixing (or appending) at least two of the rest of the background signals. At least one of the background signals may be provided by repeating (or appending) one of such background signals for a preset number of times. The system may allow the user to play and/or to hear each of such background signals before the superposing. The system may play the retrieved signal to the user during the superposing. Such a system may instead play the compound and/or outgoing signals to the user during the superposing. The user may adjust an amplitude of the retrieved signal during the superposing. The processing unit may adaptively adjust an amplitude of the retrieved signal in proportion to that of the input signal. The control member, control unit, and/or processing unit may also remove or attenuate at least a portion of a noise signal included in the input, retrieved, compound, and/or output signals. The input signal may be separated into at least one content signal and at least one noise signal so that the control member, control unit, and/or processing unit may generate the compound signal by superposing the retrieved signal onto the content signal of the input signal. The retrieved signal may be separated into a content signal and a noise signal, where the control member, control unit, and/or processing unit may generate the compound signal by superposing the content signal of the retrieved signal onto the input signal.

The transmitting member may transmit the compound signal without performing an manipulation thereof and, thus, the outgoing signal becomes identical to the compound signal. Such compound and outgoing signals may have different amplitudes, harmonics, and so on. The control member and/or its processing unit may superpose only a (or an entire) portion of the retrieved signal onto only a (or an entire) portion of the input signal. In the alternative, the control member and/or its processing unit may superpose only a (or an entire) portion of such a retrieved signal repeatedly onto only a (or an entire) portion of the input signal. The control member and/or its processing unit may also superpose only (or entire) portions of at least two of such a retrieved signal onto only a (or an entire) portion of the input signal according to a preset order. The transmitting member may superpose at least another of such background signals onto the compound signal while generating such an outgoing signal. The control member and/or unit may neither retrieve nor superpose any of the background signals onto the input signal and, thus, the outgoing signal may become identical to the input signal. An amplitude of at least one of the retrieved, compound, and outgoing signals may also be at least partially dependent upon an amplitude of the incoming signal.

The control member and/or unit may retrieve the background signal as it has been stored in the memory unit. The control member and/or unit may generate the retrieved background signal by at least partially manipulating a signal stored in the memory unit. The control member and/unit may provide the retrieved background signal by at least partially manipulating multiple signals as stored in the memory unit. The system may include at least one receiving member which is arranged to receive an incoming signal from a third party. The transmitting member may transmit at least one of such signals through wire or wirelessly. The receiving member may also receive at least one of the signals through wire or wirelessly.

In another aspect of the present invention, various communication network may be provided.

In one exemplary embodiment of this aspect of the present invention, a communication network may be comprised of a communication provider and at least one communication device. The provider may provide a network of at least one of wireless and wired paths for multiple signals to be received from and/or sent to an user. Such a device may receive at least one input signal from the user, store therein multiple background signals, receive at least one user command, retrieve at least one of such background signals based upon the user command, generate a compound signal by superposing the retrieved signal over the input signal in real time, generate an outgoing signal at least partly based on the compound signal, and transmit the outgoing signal to the provider which may receive and transmit the outgoing signal through the network.

In another exemplary embodiment of such an aspect of the present invention, a communication network may be comprised of a communication provider and at least one communication device. The provider may provide a network of at least one of wireless and wired paths for multiple signals sent to and received from an user. The device may receive at least one input signal from the user, receive at least one user command, and transmit both of the input signal and user command to the provider. The provider may also store multiple background signals, receive the input signal and user command, retrieve at least one of the background signals based upon the user command, generate a compound signal by superposing the retrieved signal over such an input signal in real time, generate an outgoing signal at least partly based on the compound signal, and then transmit the outgoing signal through the network.

In another exemplary embodiment of such an aspect of the present invention, a communication network may be comprised of a communication provider, at least one communication device, as well as a signal superposing system. The provider may provide a network of at least one of wireless and wired paths for multiple signals sent to and/or received from an user, while the device may receive at least one input signal from the user and transmit an outgoing signal to the provider. The system may be incorporated into the device and arranged to store multiple background signals, to receive at least one user command, to retrieve at least one of such background signals based upon the command, to generate a compound signal by superposing the retrieved signal over the input signal in real time, and to send the compound signal to the device. Such a device may also generate the outgoing signal at least in part based on the compound signal and transmit the outgoing signal to the provider which may be arranged to receive and then transmit the outgoing signal through the network.

In another exemplary embodiment of such an aspect of the present invention, a communication network may be comprised of a communication provider, at least one communication device, as well as a signal superposing system. The provider may provide a network of at least one of wireless and wired paths for multiple signals which may be sent to and/or received from an user and store multiple background signals, while the device may receive an input signal from the user. The system may be incorporated into the device and arranged to receive at least one user command, to retrieve at least one of the background signals based upon the user command from the provider through the network, to generate a compound signal by superposing the retrieved signal over the input signal in real time, and to send the compound signal to the device. Such a device may also generate an outgoing signal at least in part based upon the compound signal and transmit the outgoing signal to the provider which may receive and then transmit the outgoing signal through the network.

In another exemplary embodiment of such an aspect of the present invention, a communication network may be comprised of a communication provider, at least one communication device, as well as a signal superposing system. The provider may provide a network of at least one of wireless and wired paths for multiple signals sent to and/or received from an user and to include a processing unit capable of superposing one signal over another signal, and the device may receive at least one input signal from the user and transmit an outgoing signal to the provider. The system may be incorporated into the device and arranged to store multiple background signals therein, to receive at least one user command, to retrieve at least one of such background signals based upon the user command, and to send the retrieved signal to the device. The device may also transmit the input and retrieved signals to the provider which may generate a compound signal by superposing such a retrieved signal over the input signal in its processing unit, to generate the above outgoing signal at least in part based upon the compound signal, and to then transmit the outgoing signal through the network.

In another exemplary embodiment of such an aspect of the present invention, a communication network may be comprised of a communication provider, at least one communication device, as well as a signal superposing system. The provider may provide a network of at least one of wireless and wired paths for multiple signals sent to and received from an user, whereas the device may receive an input signal from the user. The system may be incorporated into the device and arranged to store multiple background signals therein, to receive at least one user command, to retrieve at least one of the background signals based upon the user command, and to send the retrieved signal to the device. Such a device may be arranged to transmit both of the input signal and retrieved signal to the provider which is arranged to transmit both of the retrieved signal and input signal through the network.

In another aspect of the present invention, a communication network may be provided in order to allow an user to receive an incoming signal and to transmit an outgoing signal therethrough, while superposing at least one background signal selected by the user onto an input signal from the user.

In one exemplary embodiment of this aspect of the present invention, a communication network may include a communication provider, at least one communication device, at least one memory unit, at least one control unit, at least one processing unit, and at least one transmitting unit. The provider may provide the network defining at least one of wireless and wired paths for multiple signals which may be sent to and/or received from the user. The device may receive the input signal from the user and transmit the outgoing signal to the provider. The memory unit may be incorporated into the device and arranged to store therein multiple background signals. The control unit may be incorporated in such a device and arranged to receive at least one user command and then to retrieve at least one of such background signals based upon the user command from the memory unit. The processing unit may be incorporated into the device and also arranged to generate a compound signal by superposing such a retrieved signal over the input signal in real time. The transmitting unit may be incorporated into such a device and also arranged to generate the outgoing signal at least in part from the compound signal and to send the outgoing signal to the provider.

In another exemplary embodiment of such an aspect of the present invention, a communication network may also include a communication provider, at least one communication device, at least one memory unit, at least one control unit, at least one processing unit, and at least one transmitting unit. The provider may provide the network defining at least one of wireless and wired paths for multiple signals sent to and received from the user, while the device may receive the input signal and an user command from the user and transmit the input signal and user command to the provider. The memory unit may be incorporated into the provider and arranged to store therein multiple background signals. The control unit may be incorporated into the provider and arranged to receive the user command from the device and to retrieve at least one of the background signals based on the user command from the memory unit. The processing unit may be incorporated into the provider and also arranged to receive the input signal and to generate a compound signal by superposing the retrieved signal over the input signal in real time. The transmitting unit may be incorporated in the provider and arranged to generate the outgoing signal at least in part from the compound signal. Such a provider may then transmit such a outgoing signal through the network.

In another exemplary embodiment of such an aspect of the present invention, a communication network may include a communication provider, at least one memory unit, at least one communication device, at least one control unit, at least one processing unit, and at least one transmitting unit. Such a provider may provide the network defining at least one of wireless paths and wired paths for multiple signals sent to and received from the user, while the memory unit may be incorporated in the provider and capable of generating multiple background signals in real time. The device may receive the input signal from the user and transmit the outgoing signal to the provider, where such a control unit may be incorporated into the device and arranged to receive at least one user command, to transmit the user command to the provider through the network, and to retrieve at least one of the background signals based upon the user command from the provider. The processing unit may also be incorporated into the device and arranged to generate a compound signal by superposing the retrieved signal over the input signal in real time. The transmitting unit may be incorporated into such a device and arranged to generate the outgoing signal at least in part from the compound signal and to send the outgoing signal to the provider.

In another aspect of the present invention, a communication device may also be provided for a communication network comprised of a communication provider and multiple devices, where such a provider may form a network of at least one of wireless and wired paths for multiple signals sent to and/or received from an user and where the device may receive at least one user command from the user.

In one exemplary embodiment of this aspect of the present invention, a communication device may have at least one transmitting member and at least one control member. The transmitting member may receive at least one input signal from the user and then transmit an outgoing signal to the provider through the network. The control member may store multiple background signals, operatively couple with the transmitting member, retrieve at least one of such background signals based upon the user command, generate a compound signal by superposing the retrieved signal over the input signal in real time, and then send the compound signal to the transmitting member which may generate the outgoing signal at least in part from the compound signal.

In another exemplary embodiment of such an aspect of the present invention, a communication device may include at least one transmitting member and at least one control member. The transmitting member may receive at least one input signal from the user and transmit the user command as well as an outgoing signal to the provider through the network. Such a control member may also operatively couple with the transmitting member, receive at least one retrieved signal from the provider through the network, generate a compound signal by superposing the retrieved signal over the input signal in real time, and send thereafter the compound signal to the transmitting member which may generate the outgoing signal at least in part from the compound signal. In one example, such a provider may store multiple background signals, receive the user command from such a device, select the retrieved signal from the background signals based upon the user command, and then transmit the retrieved signal to the device through such a network thereafter. In another example, the provider may generate multiple background signals in the real time, select one of the background signals as the retrieved signal based on the user command, and transmit the retrieved signal to the device in the real time.

In another exemplary embodiment of such an aspect of the present invention, a communication device may include at least one transmitting member and at least one control member. The transmitting member may receive at least one input signal from the user and then transmit an outgoing signal to the provider through the network. The control member may include at least one memory unit, at least one control unit, and at least one processing unit. The memory unit may store multiple background signals, while the control unit may retrieve at least one of the background signals from the memory unit based on the user command. Such a processing unit may receive the input and retrieved signals, generate a compound signal by superposing the retrieved signal over the input signal in real time in a preset mode determined by the user command, and send such a compound signal to the transmitting member which may generate the outgoing signal at least in part from the compound signal. The processing unit may perform other functions. In one example, the unit may manipulate an amplitude of the retrieved signal in the superposing based upon the mode. In another example, such a unit may control a ratio of an amplitude of the retrieved signal to that of the input signal during the superposing based on the mode. In another example, such a unit may control an amplitude of the retrieved signal in a preset temporal pattern in the superposing based on the preset mode. In another example, such a unit may manipulate an amplitude of the retrieved signal in the superposing adaptively with respect to or in proportion to an amplitude of the input signal based upon the preset mode.

Embodiments of the above aspects of various networks and devices of the present invention may further include one or more of the following features.

Such a provider may transmit such an outgoing signal through the network without making any modification. The provider may modify at least a portion of the outgoing signal and thereafter transmit the modified outgoing signal through the network.

The retrieved background signal may be prerecorded and stored in the provider. The retrieved background signal may be provided by the provider in real time with the input signal. Such a retrieved background signal may be provided by the provider in real time in a location in which the user may not be located.

The processing unit may be arranged to manipulate an amplitude of the retrieved signal during the superposing. The processing unit may to manipulate a ratio of an amplitude of the retrieved signal to that of the input signal during the superposing. Such a unit may also manipulate an amplitude of the retrieved signal in a preset temporal pattern during the superposing. The unit may instead manipulate an amplitude of the retrieved signal in the superposing adaptively with respect to an amplitude of such an input signal based upon the preset mode.

Such background signals may define preset lengths and the processing unit may generate the compound signal by repeating such superposing until the input signal which is longer than the preset length of the retrieved signal terminates or stops. The background signals may define preset lengths and the processing unit may generate the compound signal by performing the superposing of at least two of the retrieved background signals in a preset order until the input signal which is longer than a sum of the preset lengths of the at least two of the retrieved signals may terminate. The background signals may also have preset lengths, and the processing unit may generate the compound signal by superposing one of at least two of the retrieved background signals in a preset order and to continue the superposing in a different order until the input signal which may be longer than a sum of the preset lengths of the at least two of the retrieved signals may terminate or stop. Other features which have been described with reference to various systems of the first six aspects of this invention may apply to various networks and/or devices of the above three aspects of this invention as well.

In another aspect of the present invention, a method is provided for transmitting an outgoing signal obtained by superposing at least two signals with a communication device.

In one exemplary embodiment of this aspect of the invention, a method may include the steps of: acquiring multiple background signals each connoting a different event with the device; receiving an input signal from an user in real time with such a device; retrieving one of the background signals connoting one of the events; generating the outgoing signal by superposing the retrieved signal onto the input signal in the real time with the device; and transmitting the outgoing signal with the device to a third party while connoting that the user is involved in such one of the events.

In another exemplary embodiment of such an aspect of the invention, a method may include the steps of: acquiring multiple background signals each connoting different locations with such a device; receiving an input signal from an user in real time with the device; retrieving one of such background signals connoting one of the locations; generating the outgoing signal with the device by superposing the retrieved signal onto the input signal in the real time; and transmitting the outgoing signal with the device to a third party while connoting that the user is in such one of the locations.

In another exemplary embodiment of such an aspect of the invention, a method may include the steps of: acquiring multiple background signals with the device; receiving at least one user command from an user with the device; receiving an input signal from the user after such acquiring and in real time with the device; retrieving at least one of the background signals based upon the user command; generating the outgoing signal with the device by superposing the retrieved signal onto the input signal in the real time; and transmitting the outgoing signal with the device.

In another aspect of this invention, a method is provided for generating an outgoing signal by superposing at least two signals while matching their amplitudes according to an user command using a communication device.

In one exemplary embodiment of this aspect of the invention, a method may include the steps of: acquiring at least one background signal with the device; manipulating an amplitude of the acquired signal based on the user command; receiving an input signal with the device; and then generating the outgoing signal by superposing the manipulated signal onto the input signal with the device.

In another exemplary embodiment of such an aspect of the invention, a method may include the steps of: acquiring at least one background signal with the device; receiving an input signal with such a device; receiving a target ratio of an amplitude of such an acquired signal to that of the input signal; manipulating an amplitude of the acquired signal to satisfy the target amplitude ratio; and generating the outgoing signal by superposing the manipulated signal onto the input signal with the device.

In another exemplary embodiment of such an aspect of the invention, a method may include the steps of: acquiring at least one background signal with the device; receiving a target temporal pattern of the background signal; manipulating an amplitude of the acquired signal in order to satisfy the target temporal pattern; receiving an input signal with the device; and then generating the outgoing signal by superposing the manipulated signal onto the input signal with the device.

In another aspect of this invention, a method is provided for generating an outgoing signal by superposing at least two signals defining different durations using a communication device.

In one exemplary embodiment of this aspect of the invention, a method may include the steps of: acquiring a background signal of a shorter duration with the device; receiving an input signal of a longer duration with the device; and generating the outgoing signal by superposing the acquired signal onto the input signal with the device repeatedly until the longer input signal terminates.

In another exemplary embodiment of such an aspect of the invention, a method may include the steps of: acquiring a background signal of a shorter duration by the device; defining multiple different sections in such an acquired signal; receiving an input signal having a longer duration with the device; generating an initial portion of the outgoing signal by superposing the shorter acquired signal onto the input signal with the device until the shorter acquired signal stops; and appending to the initial portion of the outgoing signal its subsequent portion by superposing the sections of the acquired signal in a preset order, repeatedly when necessary, until the longer input signal terminates.

In another exemplary embodiment of such an aspect of the invention, a method may include the steps of: acquiring multiple background signals each with a shorter duration with the device; receiving an input signal of a longer duration with the device; and generating the outgoing signal by superposing each of the shorter acquired signals onto the input signal with the device in a preset order, repeatedly when necessary, till the longer input signal terminates.

In another exemplary embodiment of such an aspect of the invention, a method may include the steps of: acquiring multiple background signals each with a shorter duration with the device; receiving an input signal of a longer duration with the device; generating an initial portion of the outgoing signal by superposing such multiple shorter acquired signals onto the input signal by the device in one order until the shorter acquired signals terminates; and then appending to the initial portion of the outgoing signal its subsequent potion by superposing such multiple shorter acquired signals in another order, repeatedly in yet another order when necessary, until the longer input signal terminates.

In another aspect of the present invention, a method is provided for transmitting an outgoing signal composed of at least two real-time signals using a communication device.

In one exemplary embodiment of this aspect of the invention, a method may include the steps of: receiving an input signal from an user in real time by the device; acquiring at least one background signal connoting a preset event happening in the real time; generating the outgoing signal with such a device by superposing the acquired signal onto the input signal in the real time; and transmitting such an outgoing signal with the device while carrying an impression that the user is involved in the preset event.

In another exemplary embodiment of such an aspect of the invention, a method may include the steps of: receiving at least one user command from an user with the device; receiving an input signal from the user in real time with the device; acquiring at least one background signal of a preset event which is happening in the real time based upon the user command; generating the outgoing signal with the device by superposing the acquired signal onto the input signal in the real time; and transmitting the outgoing signal with such a device while carrying an impression that the user is involved in the preset event.

In another exemplary embodiment of such an aspect of the invention, a method may include the steps of: receiving with the device an input signal from the user disposed in one location in real time; acquiring with the device at least one background signal representing a preset event which may be happening in another location in the real time; generating the outgoing signal by superposing such an acquired signal onto the input signal in the real time with the device; and then transmitting the outgoing signal with the device while carrying an impression that the user is positioned in the another location.

In another aspect of the present invention, a method is provided for initiating and/or terminating superposition of multiple signals for a communication device.

In one exemplary embodiment of this aspect of the invention, a method may include the steps of exposing through a body of the device a switch moving between an off-position and on-position; moving such a switch to the on-position; receiving an input signal from the user; acquiring at least one background signal; and generating an outgoing signal with the device by superposing the acquired signal onto the input signal in real time until either the input signal stops or the switch moves to the off-position.

In another exemplary embodiment of such an aspect of the invention, a method may include the steps of: exposing through at least a portion of such a body of the device a switch moving between multiple positions; receiving an input signal from the user; also acquiring multiple background signals; selecting one of the background signals by moving the switch to one of the positions; and generating an outgoing signal with the device by superposing the acquired signal onto the input signal in real time

In another aspect of the present invention, a method is provided for receiving and transmitting signals through a communication network.

In one exemplary embodiment of this aspect of the invention, a method may include the steps of: providing a network of at least one of wireless paths and wired paths for multiple signals by a communication provider; establishing communication of the signals between the provider and at least one communication device through the network; acquiring multiple background signals with the device; receiving an input signal from an user with the device; retrieving at least one of the above background signals with the device; generating an outgoing signal with the device by superposing the retrieved signal onto the input signal in real time; and transmitting the outgoing signal from the device to such a provider through the network.

In another exemplary embodiment of such an aspect of the invention, a method may include the steps of: providing a network of at least one of wireless paths and wired paths for multiple signals by a communication provider; acquiring by and then storing in the provider multiple background signals; establishing communication of such signals between at least one communication device and provider through the network; receiving an input signal and user command from an user with such a device; transmitting the user command to the provider, retrieving at least one of the background signals based upon the command in the provider; transmitting the retrieved signal from the provider to such a device through the network; generating an outgoing signal by the device by superposing the retrieved signal onto the input signal in real time; and thereafter transmitting the outgoing signal from the device to the provider through the network.

In another exemplary embodiment of such an aspect of the invention, a method may include the steps of: providing a network of at least one of wireless paths and wired paths for multiple signals by a communication provider; enabling the communication provider to superpose one signal onto another signal; establishing communication of such signals between the communication provider and at least one communication device through the network; acquiring multiple background signals with the device; receiving an input signal from an user in real time with the device; retrieving with the device at least one of the background signals; transmitting the retrieved and input signals to the provider through the network; generating an outgoing signal with the provider by superposing the retrieved signal onto the input signal in real time; and transmitting the outgoing signal by the provider through the network.

In another exemplary embodiment of such an aspect of the invention, a method may include the steps of: providing a network of at least one of wireless paths and wired paths for multiple signals by a communication provider; acquiring by and then storing in the provider multiple background signals; enabling the provider to superpose one signal onto another signal; establishing communication of the signals between the provider and at least one communication device through the network; receiving an input signal and an user command from an user with the device; transmitting the input signal and user command to the provider through the network; retrieving at least one of the background signals based upon the command in the provider, generating an outgoing signal by superposing the retrieved signal onto the input signal in real time with the provider; and transmitting the outgoing signal by such a provider through the network.

In another aspect of the present invention, a method is also provided for superposing multiple signals using a communication network.

In one exemplary embodiment of this aspect of the invention, a method may include the steps of: providing a network of at least one of wireless paths and wired paths for multiple signals by a communication provider; establishing communication of the signals between the provider and at least one communication device through the network; acquiring with the device multiple background signals each representing one of an event and a location in which an user of the device may not be involved; storing the background signals in the device; receiving an input signal from an user with the device after the above storing; retrieving at least one of the background signals with the device; generating an outgoing signal with the device by superposing the retrieved signal onto the input signal in real time; and transmitting such an outgoing signal from the device to a third party through the network, thereby giving the third party an impression that the user is likely to be involved in the one of the event and location.

In another exemplary embodiment of such an aspect of the invention, a method may include the steps of: providing a network of at least one of wireless paths and wired paths for multiple signals by a communication provider; establishing communication of such signals between such a provider and at least one communication device through the network; enabling the provider to acquire at least one background signal in real time each representing one of an real-time event and a real-time location in which an user of the device is not involved; enabling the provider to superpose one signal on another signal; receiving an input signal and an user command from an user with the device; transmitting such an input signal and user command to the provider through the network; retrieving at least one of such background signals based on the command in the provider; generating an outgoing signal with such a provider by superposing the retrieved signal onto the input signal in real time; and transmitting such an outgoing signal by the provider to a third party through the network, thereby giving the third party an impression that the user is likely to be involved in the one of the event and location.

Embodiments of the foregoing method aspects of the present invention may also include one or more of the following features.

The acquiring may include the step of: obtaining the background signals by the device, from another signal processing or storage device, from a provider of a communication network, and so on. The acquiring may include one of the steps of: storing such a background signal as it is obtained; and storing the background signal after modifying at least a portion thereof. Such retrieving may include one of the steps of: selecting the at least one of the background signals as it is acquired (or stored); and selecting the at least one of the background signals and modifying at least a portion thereof.

The superposing may include one of the steps of: superposing only a (or an entire) portion of the retrieved (or acquired) signal onto the input signal; and superposing such a retrieved (or acquired) signal onto only a (or an entire) portion of the input signal. Such superposing may include one of the steps of: repeating such an acquired or retrieved signal in the superposing; repeating a set of multiple acquired or retrieved signals in a preset order during the superposing; and repeating a set of multiple acquired or retrieved signal in different orders during the superposing.

Such manipulating may include the step of: changing the amplitude of at least a (or an entire) portion of the acquired (or retrieved) signal. The generating may include one of the steps of: using the superposed signals as it is as such an outgoing signal; and modifying at least a portion thereof. Such transmitting may include the step of: sending such a signal wirelessly or through wire. Such receiving and/or transmitting may include the step of: receiving and/or transmitting audio signals, video signals, audiovisual signals, and the like. Other features may be similar and/or identical to those for the above apparatus claims.

In another aspect of the present invention, various communication systems may be provided to superpose various signals one over the other.

In one exemplary embodiment of this aspect of the invention, such a system may be provided by a process including the steps of: incorporating a transmitting member for receiving an input signal from an user and transmitting an outgoing signal; and providing a control member capable of storing multiple background signals, receiving at least one user command, retrieving at least one of the above background signals based on the user command, generating a compound signal by superposing the retrieved signal over the input signal in real time, and sending the compound signal to the transmitting member which is arranged to generate the outgoing signal at least in part from the compound signal.

In another exemplary embodiment of this aspect of the present invention, such a system may be provided by a process including the steps of: incorporating a transmitting member for receiving an input signal from an user and transmitting an outgoing signal; providing a control member with at least one memory unit, at least one control unit, and at least one processing unit; enabling the memory unit to store multiple background signals; enabling the control unit to receive at least one user command and to retrieve at least one of the background signals from the memory unit based upon the command; enabling the processing unit to receive the input and retrieved signals, to generate a compound signal by superposing the retrieved signal over the input signal in real time in a preset mode based upon the user command, and then to send the compound signal to the transmitting member for generating such an outgoing signal at least in part from the compound signal. The process may also include one of the steps of: further arranging the processing unit to manipulate an amplitude of the retrieved signal during the superposing based on the mode; further arranging such a processing unit to control a ratio of an amplitude of the retrieved signal to that of the input signal during the superposing based on the mode; further arranging the processing unit to control an amplitude of the retrieved signal based on a preset temporal pattern during the superposing based upon such a preset mode; and further arranging such a processing unit to manipulate an amplitude of the retrieved signal during the superposing adaptively with respect to an amplitude of the input signal based upon the preset mode.

In another aspect of the present invention, a communication device is provided for transmitting an outgoing signal obtained by superposing at least two signals.

In one exemplary embodiment of this aspect of the invention, such a device may be provided by a process including the steps of: providing an input unit capable of acquiring multiple background signals each connoting a different event with the device; forming a memory unit capable of storing the background signals; receiving an input signal from an user with the input unit in real time; including a control unit for retrieving one of the background signals corresponding to one of the events; providing a processing unit for generating the outgoing signal by superposing the retrieved signal onto the input signal in the real time; and providing a transmitting unit for transmitting the outgoing signal to a third party while connoting that an user of the device is involved in the event.

In another exemplary embodiment of this aspect of the present invention, such a device may be provided by a process including the steps of: providing an input unit capable of acquiring multiple background signals each connoting a different location; forming a memory unit capable of storing the background signals; receiving an input signal from an user with the input unit in real time; including a control unit for retrieving one of the background signals corresponding to one of the events; providing a processing unit for generating the outgoing signal by superposing the retrieved signal onto the input signal in the real time; and providing a transmitting unit for transmitting the outgoing signal to a third party while connoting that an user of the device is in the one of the locations.

More product-by-process claims may be constructed by modifying the foregoing preambles of the apparatus and/or method claims and by appending thereonto such bodies of the apparatus and/or method claims. In addition, such process claims may include one or more of the above features of the apparatus and/or method claims of the present invention.

As used herein, the terms an “user” and a “third party” are persons engaged in communication through such systems and/or devices of the present invention. In this context, the term “user” refers to a person who may not only use a system and/or device of this invention but also provide his or her own voice and/or appearance into such a system and/or device as an input signal. Similarly, the term “third party” refers to a person who may not only use another system and/or device but also provide his or her own appearance and/or voice as another input signal to another system and/or device.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIG. 1A is a schematic diagram of an exemplary signal superposing system performing normal functions according to the present invention;

FIG. 1B is a schematic diagram of the signal superposing system of FIG. 1A performing signal superposition according to the present invention;

FIG. 2A is a schematic view of an exemplary communication device with a signal superposing system for audio signals according to the present invention; and

FIG. 2B is a schematic view of another exemplary communication device having another signal superposing system for audio and video signals according to the present invention.

### DETAILED DESCRIPTION OF THE PREFERRED EMBODIMENTS

The present invention generally relates to various signal superposing systems, communication devices including such systems, and communication network using such systems and devices. More particularly, the present invention relates to various signal superposing systems capable of generating an outgoing signal by superposing a background signal retrieved by an user on an input signal which is also generated by the user in real time. Therefore, the user may transmit the superposed signal to a third party while giving the party an impression that the user is currently involved in a specific situation connoted by such background signal. The present invention relates to various communication devices which may incorporate such a signal superposing system and, accordingly, generate and transmit the outgoing signal which is obtained by superposing the background signal onto the input signal, where such communication devices may utilize wire and/or wireless network to transmit the outgoing signal. The present invention further relates to various communication networks which may utilize the above signal superposing systems and/or communication devices and which may enable the user to select a desired background signal from a library of background signals. Various members and/or units of the signal superposing system may then be incorporated in various modes such as, e.g., only into such a communication device, only into a communication provider, into both of the communication device and communication provider. Accordingly, such a communication provider may be arranged to superpose the retrieved signal onto the input signal before transmitting such an outgoing signal or, alternatively, may transmit the retrieved signal and input signal separately to the third party.

The present invention relates to various methods of superposing the background signal onto the input signal in real time, various methods of communicating with the third party while superposing the background signal onto the input signal, various methods of providing various background signals to the user through the communication network, various methods of transmitting the output signal after such superposing, and various methods of transmitting the background and input signals separately to the third party. More particularly, the present invention relates to various methods of generating such an outgoing signal by superposing such a background signal onto the input signal in real time, various methods of replacing noise signals contained in the input and/or outgoing signals with the background signals, various methods of superposing such noise signals onto the input signal, various methods of communicating with the third party using such a communication device with such a signal superposing system, and various methods of transmitting such background signals, input signals, and/or outgoing signals in various modes through the communication network. The present invention further relates to various methods of distributing various members and/or units of the signal superposing system in the communication device and provider, thereby reducing a weight and/or volume of the device, acquiring the background signals connoting preset events which are happening in preset locations in real time.

The present invention also relates to various processes for providing such signal superposing systems, various processes for making and operatively coupling various members and/or units of the signal superposing systems, various processes for incorporating the members and/or units of such systems into stationary or mobile communication devices such as mobile phones and PDA's, various processes for establishing a communication network between a communication provider and at least one communication device which includes such signal superposing systems, and various processes for disposing various members and/or units of the signal superposing systems only into the provider, only into the device, or into both of the provider and device.

Various aspects and/or embodiments of such systems, devices, methods, and/or processes of the present invention will now be described more particularly with reference to the accompanying drawings and text, where such aspects and/or embodiments thereof only represent different forms. Such systems, methods, and/or processes of this invention, however, may also be embodied in many other different forms and, therefore, should not be limited to such aspects and/or embodiments which are set forth herein. Rather, various aspects and/or embodiments described herein are provided such that this disclosure will be thorough and complete, and fully convey the scope of the present invention to one of ordinary skill in the relevant art.

Unless otherwise specified, it is appreciated that various members, units, elements, and parts of various systems and devices of this invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

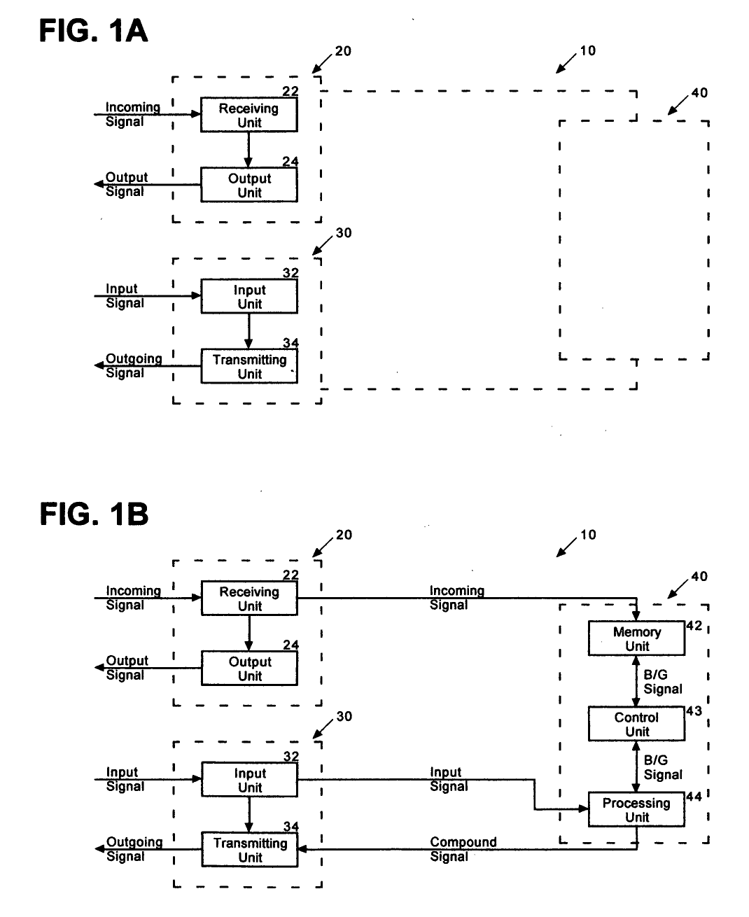

In one aspect of the present invention, various signal superposing systems are provided for communication devices. FIG. 1A is a schematic diagram of an exemplary signal superposing system performing normal functions, while FIG. 1B is a schematic diagram of the signal superposing system of FIG. 1A performing signal superposition according to the present invention. As exemplified in the figures, such a system 10 generally includes a receiving member 20, a transmitting member 30, and a control member 40, where the receiving member 20 includes a receiving unit 22 and an output unit 24, the transmitting member 30 includes an input unit 32 and a transmitting unit 34, and the control member 40 includes a memory unit 42, a control unit 43, and a processing unit 44. Such a system 10 includes another controller which controls various operations of such members and units for wired or wireless communication and which, however, is omitted from the figures for simplicity of illustration. Therefore, the control member 40 described in these figures may be viewed to control various operations during superposing various signals according to the present invention.

The system 10 of FIG. 1A performs ordinary functions for communication between an user of the system 10 and a third party. For example, the receiving unit 22 is arranged to receive an incoming signal issued by the third party, and the output unit 24 is arranged to convert such an incoming signal into an audio and/or video output signal and to play the audio output signal and/or to display the video output signal. In response to such an incoming signal, the user generates an audio and/or video input signal and provides the input signal to the input unit 32. The transmitting unit 34 is arranged to convert the input signal into an electromagnetic, electric, and/or optical outgoing signal and to transmit such an outgoing signal to the third party wirelessly and/or through wire. Another controller (not shown in the figure) controls various operations of these receiving and transmitting members 20, 30 for the above communication such as, e.g., receiving and converting the incoming signal, receiving and converting the input signal, generating and transmitting the outgoing signal, and the like. In such an embodiment, the control member 40 is generally arranged to not perform signal superposition onto the input signal. Accordingly, the outgoing signal is similar to the input signal or, in other words, a content signal of the outgoing signal is similar to another content signal included in the original input signal, although a noise signal of the input signal may be removed or at least partly attenuated by various filters and/or filtering mechanisms of the system 10 which may be included in another controller and not included in these figures.

As shown in FIG. 1B, the control system 40 may be arranged to perform signal superposition. For example, the memory unit 42 may be arranged to store therein multiple signals each of which may be used as a new or alternative background signal for the outgoing signal as will be described below. The control unit 43 may be arranged to receive an user command and may be operatively coupled to the memory unit 42 in order to interact therewith. For example, the control unit 43 may select and/or retrieve one or more background signals from the memory unit 42 based on the user command, store one or more signals into the memory unit 42 based on such a command, generate a new background signal by manipulating one or more background signals already stored in the memory unit 42, and the like. The processing unit 44 may be operatively coupled to the control unit 43 and arranged to receive the retrieved background signal from the control unit 43. The processing unit 44 may also operatively couple with the input unit 32 and receive the input signal therefrom. The processing unit 44 may then generate a compound signal by superposing at least a (or entire) portion of the selected or retrieved (background) signal onto or over at least a (or entire) portion of the input signal. The processing unit 44 may also operatively couple with the transmitting unit 34 and send the compound signal thereto.

In operation, the user first receives an incoming call from the third party through the receiving member 20 or calls the third party by sending a signal to the third party through the transmitting unit 34. At this moment, the user may decide whether or not to activate the signal superposing system. When the user wants to forego the signal superposition, he or she simply turns on the communication device and communicates with the third party as usual. When the user desires such signal superposition, he or she provides a specific command to the system 10 such that the control member 40 may begin the signal superposition as exemplified in FIG. 1B. First, the receiving member 20 performs the normal or conventional functions so that the receiving unit 22 receives the incoming signal and the output unit 24 plays the audio incoming signal and/or displays the video incoming signal to the user. Depending upon the user command, the control unit 43 may select or retrieve one or more background signals from the memory unit 42 and send such a retrieved signal to the processing unit 44 with or without performing any modification of the retrieved signal. The processing unit 44 receives the input signal generated by the user from the input unit 32 and the retrieved signal from the control unit 43, combines such signals by superposing at least a (or entire) portion of the retrieved signal onto (or over) at least a (or entire) portion of the input signal in real time, and sends to the transmitting unit 34 the resulting superposed or compound signal. The transmitting unit 34 may then generate the outgoing signal from the compound signal with or without performing any modification thereof and transmit the outgoing signal to the third party, thereby giving the third party an impression that the user is very likely to be involved in a preset situation which is connoted by the retrieved background signal.

In another aspect of the present invention, various communication devices may include one of various signal superposing systems of the present invention.

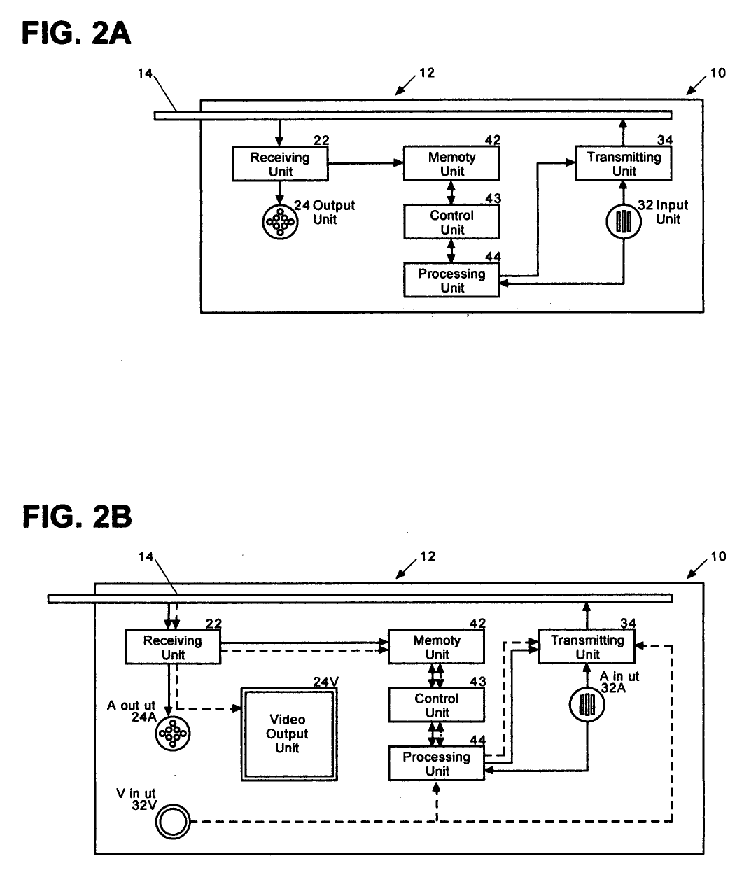

In one exemplary embodiment of this aspect of the present invention, a communication device may include an audio signal superposing system. FIG. 2A shows a schematic view of an exemplary communication device having a signal superposing system for audio signals according to the present invention. A communication device 12 of FIG. 2A is generally similar to a conventional mobile phone or a handset of a conventional telephone, and includes an antenna 14, a receiving unit 22, an output unit 24, an input unit 32, a transmitting unit 34, and a signal superposing system 10 which in turn includes a memory unit 42, a control unit 43, and a processing unit 44. All of such receiving, output, input, and transmitting units 22, 24, 32, 34 are arranged to perform similar functions as described hereinabove, where the output unit 24 may be a conventional speaker and the input unit 32 may be a conventional microphone. The antenna 14 may be exposed out of or embedded into the device 12 and arranged to facilitate receiving and/or transmitting various signals.

As described hereinabove, the memory unit 42 stores therein multiple background signals each of which may be utilized as a new background signal of the outgoing signal. The memory unit 42 may acquire such background signals by a variety of means. For example, the memory unit 42 may record the incoming signal from the third party and store such as a new background signal. Similarly, such a memory unit 42 may record the input signal of the user and store such as another background signal. When desirable, the memory unit 42 may be arranged to acquire various signals through the input unit 32 and store such as the background signals. In this example, the user may record any audio signals and use such in later occasions. For example, he or she may record audible signals associated with a meeting (e.g., conversation among multiple persons), a class (e.g., a professor giving a lecture), a musical session (e.g., sounds of various musical instruments mixed with instructions from a teacher), a concert (e.g., well organized and harmonious music), a nursery (e.g., crying babies), a traffic jam (e.g., honking sounds and/or drivers yelling at each other), a bar (e.g., conversation and background music), a work environment (e.g., sounds of heavy machinery in a construction site), a fight or brawl (e.g., people shouting at each other with occasional bangings, hittings, and shovings), and the like. In another example, the user may also import various signals from other electric devices and/or through an internet and store such in the memory unit 42 as the new background signals. In another example, a manufacturer may provide various background signals in such a memory unit 42. The memory unit 42 may also record and/or import various mechanical and/or electrical signals such as, e.g., humming or whirling noises, dialing tones or other tones commonly generated in telephone communications, and the like. The main function of the memory unit 42 is to store various signals which may be used as the background signals for the superposed or compound signals. Therefore, the memory unit 42 may be arranged to perform other auxiliary functions as long as such functions may facilitate storing a greater amount of signals (e.g., compression and decompression of signals), may help selection or retrieval of specific signals (e.g., indexing, cataloging, classifying multiple signals), and the like. It is appreciated that such a memory unit 42 may be arranged to passively import such signals from various audio or video input units or, in the alternative, may also be arranged to actively acquire such signals through such audio or video input units.

The processing unit 44 may be arranged to superpose the background signals onto the input signal in a variety of modes. In one example, the processing unit 44 may superpose a single retrieved signal onto the input signal. When the retrieved signal has a period longer than that of the input signal, the processing unit 44 may simply superpose any portion of the retrieved signal onto the input signal, and terminates the superposition when the input signal terminates. As the input signal continues and lasts longer than the retrieved signal, however, the signal processing unit 44 may need to be provided with another algorithm capable of superposing the shorter retrieved signal onto the longer input signal.

Accordingly and in another example, such a processing unit 44 may be arranged to repeatedly superpose the retrieved signal onto the input signal as such an input signal continues longer than the retrieved signal. The processing unit 44 may repeat to superpose an entire portion of such a retrieved signal of a finite duration onto the input signal. Alternatively, the processing unit 44 may superpose a different version of the retrieved signal during repeated superposition, e.g., by superposing different portions of the retrieved signal, by performing the superposition at different starting points, and so on.

In another example, the control member 40 may retrieve more than one background signal from the memory unit 42 and the processing unit 44 may superpose such multiple retrieved signals onto the input signal. In particular, when the input signal continues longer than the first retrieved signal, such a processing unit 44 may superpose the second retrieved signal, and so on, according to a preset order as determined by the user command. When the processing unit 44 superposes all background signals retrieved from the memory unit 42 but the input signal still persists, the processing unit 44 may begin to roll back to the first retrieved signal and repeat the superposition in the same order as many times as needed. In a related example, the processing unit 44 may superpose the retrieved signals according to a first order and, when the input signal persists, then repeat the superposition in a different order which may be determined by the user command or by a conventional random sequence generator.

In another related example, such a control member 40 may retrieve multiple background signals from the memory unit 42 and the processing unit 44 may modify or alter the retrieved signals when the input signal continues after the retrieved signals run out. For example, the processing unit 44 may be arranged to change amplitudes or other wave characteristics of the retrieved signals and superpose the modified retrieved signals onto the input signal. In another example, the processing unit 44 may be arranged to mix two or more retrieved signals and then superpose such mixed retrieved signals onto the input signal.

It is appreciated that one of main features of the signal superposing system 10 of this invention is to superpose the retrieved signal onto the input signal in real time. Accordingly, the system 10 may be arranged to prepare in advance for such longer input signals by various means. For example, the memory unit 42 may classify such background signals into various categories and store such signals according to such categories. Based upon the user command, the memory unit 42 may then select or retrieve a series of background signals from the same category so that multiple background signals of the same or similar effects may be superposed onto the longer input signal as need arises. In another example, the system 10 may set up a preset order in which the background signals are superposed onto the input signal. When desirable, the system 10 may set up multiple orders of superposition and the user may select one of such orders through the user command.

It is to be understood that the memory unit 42 may be constructed by almost any conventional data storage articles capable of storing therein multiple analog and/or digital signals, where examples of such articles may include, but not be limited to, a magnetic tape, a magnetic disk, an optical disk, a microchip, and so on, where each of such articles may be read-only or read-and-write. The memory unit 42 may also include at least one driver to process the signals into and out of such articles, where examples of such drivers may include, but not be limited to, a tape player, a magnetic disk driver, an optical disk driver, and so on. Such a memory unit 42 may also include auxiliary processors capable of improving the storage capacity thereof, facilitating classification of various background signals, and so on. The memory unit 42 may also be made of other conventional articles capable of storing multiple analog or digital data therein.

Another function of the processing unit 44 is to supply such a superposed or compound signal in real time to the transmitting unit 34 which may generate the outgoing signal at least in part from such a compound signal. In order to facilitate transmission thereof, the outgoing signal may have a different format from that of the compound signal, although their content must be at least substantially similar or identical. However, the memory unit 42 may be arranged to store multiple background signals in such a transmission format, and the control unit 43 may retrieve one or more of the background signals and supply such retrieved signal to the processing unit 44 which may then send to the transmitting unit 34 the compound signal which is also in the transmission format. In such a case, the transmitting unit 34 may not have to change the format of the compound signal and, therefore, the compound signal and outgoing signal may be identical signals with identical content signals in an identical format.

The control unit 43 may be arranged to receive the user command issued by the user of such a system 10. To this end, the control unit 43 may incorporate any conventional input modules which may recognize mechanical and/or electrical command signals, where examples of such modules may include, but not be limited to, a key, a keypad, a tactile transducer, a force transducer, and so on. The control unit 43 may preferably be arranged to search through the memory unit 42 and to retrieve one or more background signals depending upon the user command. In one example, the user command may specify an address of a desired background signal so that the control unit 43 may simply retrieve the signal stored in such an address. In another example, the user command may specify a desired category of one or more background signals and the control unit 43 may retrieve one of such signals in the category, some or all of such signals in that category. When desirable, the control unit 43 may also be arranged to process the selected background signal in order to generate the retrieved signal, e.g., by decompressing the compressed background signal, by changing an amplitude of the signal, by combining multiple background signals, and the like. Whatever format such background signals may be stored in the memory unit 42, the control unit 43 may be arranged to retrieve and then to deliver such a retrieved signal to the processing unit 44 in a format which may be processable by such a processing unit 44.

The control member 40, control unit 43, and/or processing unit 44 (to be collectively referred to as the “control member” hereinafter) may be arranged to control various dynamic characteristics of the superposition by various means. In one example, the control member 40 may retrieve at least one background signal from the memory unit 42 and superpose such a signal as it has been stored in the memory unit 42 onto the input signal. In another example, the control member 40 may select a preset level of an amplitude of the background signal based upon the user command and superpose such a signal with the preset level of amplitude onto the input signal. Accordingly, the user may increase or decrease the amplitudes of the retrieved signal through the control member 40, thereby increasing or decreasing such a ratio of the amplitude of the retrieved signal to that of the input signal. In another example, the control member 40 may select a preset ratio of an amplitude of the retrieved signal to an amplitude of the input signal based on the user command and superpose the retrieved signal onto the input signal while maintaining the amplitudes of the signals at or near the preset ratio. In this example, the preset ratio may be defined based upon an average amplitude of the retrieved signal, a setting of a volume of the device which is selected by the user. In the alternative, the preset ratio may be based upon the above average amplitude of the retrieved signal and an average amplitude of the input signal generated by the user in real time. Because the average amplitude of the input signal is expected to change over time, the control member 40 may be arranged to change the amplitudes of the retrieved signal adaptively according to or in proportion to the average amplitude of the input signal. In another example, the control member 40 may instead select a desired temporal pattern of the amplitude of the retrieved signal based upon the user command, and then superpose the retrieved signal over such an input signal according to the selected pattern. Therefore, the user may increase the amplitude of the retrieved signal over time as if, e.g., he or she is approaching a specific location or may decrease the amplitude of the retrieved signal over time as if, e.g., he or she is walking or driving away from such a location. In the alternative, the control member 40 may randomly change the amplitude of the retrieved signal by the conventional random signal generator.

The control and/or processing units 43, 44 of the control member 40 may also be arranged to filter and/or attenuate noises contained in various signals. In one embodiment, the input signal may be separated into a content signal and a noise signal using various conventional filters, where only such a content signal may be superposed by the retrieved signal to generate the compound signal having a high signal-to-noise ratio. In another embodiment, the retrieved signal may be separated into a content signal and a noise signal by similar filters, where only the content signal may be superposed onto the input signal to generate the compound signal with a high signal-to-noise ratio. In another embodiment, the compound or outgoing signal may be separated into a content signal and a noise signal, and only the content signal thereof may be transmitted by the transmitting member 34. It is appreciated that the noise signal itself may be the background signal as described above. Accordingly, the noise signals of the above signals may also be amplified in order to intentionally reduce the signal-to-noise ratios of the input, retrieved, compound, and/or outgoing signals, thereby overwhelming the content portions of the signals.

Various members and/or units of the system 10 may also include other connections which are not shown in these figures. In one embodiment, the memory unit 42 may be arranged to store various signals sent to or received from various units 22, 24 of the receiving member 20 and/or various units 32, 34 of the transmitting member 30. To this end, the system 10 may include wire which connect the memory unit 42 with the foregoing units of the receiving and/or transmitting members 20, 30 directly or indirectly. Thereby, the memory unit 42 may receive and store at least portions of the incoming, input, and/or outgoing signals before the signal superposition (i.e., prerecorded) and then use such signals as the background signals. Such a memory unit 42 may also acquire such signals in real time and use such signals as the background signals. In another embodiment, the system 10 may also be arranged to allow the user various signals involved in the superposition operation. In one example, the memory and/or control units 42, 43 may be coupled to the output unit 24 of the receiving member 20 and allow the user to hear the background signals stored in the memory unit 42 before the signal superposition, to hear the retrieved signals before the superposition, and so on. In another example, the processing and/or transmitting units 44, 34 may be coupled to the output unit 24 in order to allow the user to hear the compound and/or outgoing signals before transmission thereof, during transmission, and the like. When desirable, the system 10 may also include an auxiliary display unit which may be coupled to the above units and allow the user to hear various signals.

In another aspect of the present invention, various communication devices may include one of various signal superposing systems of the present invention.

In one exemplary embodiment of this aspect of the present invention, a communication device may include an audio signal superposing system. FIG. 2A shows a schematic view of an exemplary communication device having a signal superposing system for audio signals according to the present invention. A communication device 12 of FIG. 2A is generally similar to a conventional mobile phone or a handset of a conventional telephone, and includes an antenna 14, a receiving unit 22, an output unit 24, an input unit 32, a transmitting unit 34, and a signal superposing system 10 which in turn includes a memory unit 42, a control unit 43, and a processing unit 44. All of such receiving, output, input, and transmitting units 22, 24, 32, 34 are arranged to perform similar functions as described hereinabove, where the output unit 24 may be a conventional speaker and the input unit 32 may be a conventional microphone. The antenna 14 may be exposed out of or embedded into the device 12 and arranged to facilitate receiving and/or transmitting various signals.

In another exemplary embodiment of such an aspect of the present invention, a communication device may include an audiovisual signal superposing system. FIG. 2B is a schematic view of another exemplary communication device including another signal superposing system for both of audio and video signals according to the present invention. The communication device 12 is generally similar to a conventional mobile phone having an image acquiring unit such as a camera, and has an antenna 14, a receiving unit 22, an audio output unit 24A, a video output unit 24V an audio input unit 32A, a video input unit 32V, a transmitting unit 34, as well as a signal superposing system 10 which in turn includes a memory unit 42, a control unit 43, and a processing unit 44. The receiving unit 22, audio output unit 24A, audio input unit 32A, and transmitting unit 34 are arranged to perform similar or same functions as those 22, 24, 32, 34 of FIG. 2A, except that the receiving and transmitting units 22, 34 are arranged to receive and transmit not only audio but also video signals, respectively. The video output unit 24V is arranged to display a video content signal of the incoming signal and may be a conventional display unit such as, e.g., an LCD, OLED, and the like. The video input unit 32V is arranged to acquire a video input signal and may be a conventional image acquiring unit such as, e.g., a camera, a CCD, and the like. The antenna 14 may be similarly exposed out of or embedded into the device 12 and arranged to facilitate receiving and/or transmitting various signals.

The memory unit 42 stores therein multiple audio and video background signals each of which may be utilized as a new audio and video background signal of the outgoing signal. The memory unit 42 may acquire various audio background signals by a variety of means which are similar to those of FIG. 2A. Such a memory unit 42 may acquire various video background signals by various means as well. For example, the memory unit 42 may record the incoming video signal from the third party and store such as a new background signal. Similarly, such a memory unit 42 may record the video input signal of the user and store such as another background signal. When desirable, the memory unit 42 may be arranged to acquire various video signals through the video input unit 32V and store such as the background signals. In this example, the user may record any video signals and use such in later occasions. For example, he or she may record video signals associated with a meeting (e.g., multiple persons sitting in a room), a class (e.g., a professor giving a lecture and students sitting in a room), a musical session (e.g., a teacher supervising students playing various musical instruments), a concert (e.g., a musician playing music in front of an audience), a nursery (e.g., babies in cribs), a traffic jam (e.g., cars lining up in an intersection), a bar (e.g., a bartender and people drinking, chatting, dancing, and so on), a work environment (e.g., heavy machinery in a construction site), a fight or brawl (e.g., people banging, hitting, and/or shoving each other), and so on. In another example, the user may also import various video signals from other electric devices and/or through an internet and store such in the memory unit 42 as the new background signals. In another example, a manufacturer may provide various video background signals in such a memory unit 42.

The processing unit 44 may be arranged to superpose the audio background signals onto the audio input signal similar to those of FIG. 2A. The processing unit 44 may be arranged to superpose the video background signals onto the video input signal as well. In one example, such a unit 44 may superpose a single retrieved video signal onto the video input signal. When the retrieved video signal lasts longer than the video input signal, such a unit 44 may simply superpose a portion of the retrieved video signal and then terminates the superposition when the video input signal stops. When the video input signal continues longer than the retrieved video signal, however, the unit 44 may need another algorithm to superpose the shorter retrieved video signal onto the longer video input signal. Therefore and in another example, such a unit 44 may be arranged to superpose the retrieved video signal onto the video input signal and thereafter repeat the superposition more than once as the video input signal lasts longer than the retrieved video signal. In this example, such a processing unit 44 may superpose the retrieved video signal of a finite duration onto the video input signal of an arbitrary length by any number of times limit. In another example, such a control member 40 may retrieve multiple background video signals from the memory unit 42 and the processing unit 44 may superpose such multiple video signals onto the video input signal. When the video input signal lasts longer than the first background video signal, the processing unit 44 may superpose the second background video signal, and the like, in a preset order based on the user command. When the processing unit 44 uses up all background video signals retrieved from the memory unit 42 but the input signal still persists, such a unit 44 may be arranged to roll back to the first background video signal and repeat such superposition according to the same order one more time. In a related example, the processing unit 44 may instead superpose the retrieved background video signals in a first order and, when the video input signal still continues, repeat the superposing in another different order which may be determined by the user command or generated by the conventional random sequence generator.

The system 10 for processing various audiovisual signals may also be arranged to prepare in advance for such longer video input signals by various means. For example, the memory unit 42 may classify various video background signals into various categories and store such signals according to such categories. Based upon the user command, the memory unit 42 may select or retrieve a series of video background signals from the same category so that multiple video background signals of the same or similar effects may then be superposed onto the longer video input signal as need arises. In another example, the system 10 may set up a preset order in which the video background signals are superposed onto the video input signal. When desirable, the system 10 may set up multiple orders of superposition and the user may select one of such orders through the user command.

Another function of such a processing unit 44 is to supply the video superposed or compound signal in real time to the transmitting unit 34 which may generate such a video outgoing signal at least in part from the video compound signal. In order to facilitate transmission thereof, the video outgoing signal may have a different format from that of the video compound signal, although their content must be at least substantially similar or identical. However, the memory unit 42 may be arranged to store multiple background signals in such a transmission format, and the control unit 43 may retrieve one or more of the video background signals and supply such video retrieved signal to the processing unit 44 which may then send to the transmitting unit 34 the video compound signal which may be also in such a transmission format. In this case, the transmitting unit 34 may not have to change the format of the compound signal and, accordingly, the video compound and outgoing signals may be identical signals with identical content signals in an identical format.

The control member 40, control unit 43, and/or processing unit 44 (to be collectively referred to as the “control member” hereinafter) may be arranged to control various dynamic characteristics of the superposition by various means. In one example, the control member 40 may retrieve at least one background video signal from the memory unit 42 and superpose the video signal as is onto the video input signal. In another example, such a control member 40 may select a level of contrast, brightness, and/or sharpness of the retrieved video signal based upon the user command and then superpose the background video signal with such a selected level of contrast, brightness, and/or sharpness onto the video input signal. In this example, the user may increase or reduce the contrast, brightness, and/or sharpness of such a background video signal through the control member 40, thereby increasing or reducing a ratio of contrast, brightness, and/or sharpness of the background video signal to those of the input signal. In another example, the control member 40 may set each ratio of contrast, brightness, and/or sharpness of the retrieved video signal to those of the video input signal and superpose such a retrieved video signal onto the video input signal while keeping such contrast, brightness, and/or sharpness of the signals at or near the preset ratio. In this example, the ratio may be defined based on an average contrast, brightness, and/or sharpness of the retrieved background video signal and upon individual settings of the device selected by the user. In the alternative, the ratio may be based upon such average contrast, brightness, and/or sharpness of the retrieved video signal and based on an average contrast, brightness, and/or sharpness of the video input signal generated by the user in real time. In this example, the average value of the video input signal is expected to change over time, while the control member 40 may change the contrast, brightness, and/or sharpness of the retrieved video signal adaptively according to the average value of the video input signal. In another example, the control member 40 may select a temporal pattern of the contrast, brightness, and/or sharpness of the retrieved video signal based upon the user command, and then superpose such a retrieved video signal over the video input signal according to the selected pattern. The control member 40 may also be arranged to manipulate other optical characteristics of the video signals, where examples of such characteristics may include, but not be limited to, a focus, focal depth, zoom, and so on. Accordingly, the user may increase the zoom of the retrieved video signal over time as if he or she is approaching a specific location or may reduce the brightness of the retrieved signal over time as if he or she may be walking into a dark room or building. Other features of the processing unit 44 for the audio signals as described above may also be applied to such a unit 44 for the video signals.

Configurational and/or operational variations and/or modifications of the above embodiments of the exemplary systems and various members and/or units thereof described in FIGS. 1A to 2B also fall within the scope of this invention.

As described above, the signal superposing system of this invention may be manufactured in various arrangements. Accordingly, such a system may be arranged to include the above receiving and/or transmitting members as exemplified in the above figures. Alternatively, such a system may be arranged to consist of the memory unit, the processing unit, and a control unit which may be capable of controlling other operations of the system and/or communication device. Accordingly, a definition of the signal superposing system and, more particularly, whether or not such a system may include the receiving or transmitting member is generally not material to the scope of the present invention, as long as such a system may be able to perform one or more of the signal superposing algorithms.

The signal superposing system and/or communication device with such a system may include other units as commonly employed in conventional communication devices. For example, the system or device may include coding and/or decoding units to respectively code and decode various signals. Such a system or device may also include various conventional signal processing algorithms in order to enhance signal-to-noise ratios of the incoming and outgoing signals. In addition, such a system or device may include storage functions capable of storing various information such as, phone numbers, names of persons, various settings selected by the user, and the like. Such a system or device may further include additional electric and/or mechanical units which are commonly used in conventional communication devices and well known to one skilled in the relevant art.

Such a control member and its control and/or processing units may be arranged to edit various audio and/or video signals based on the user commands. For example, the control member may allow the user to vary the amplitudes and/or order of the background audio signal, to delete a portion of the audio signal, to add another audio signal to the background audio signal, to extend such a background audio signal by appending thereto the same signal or another signal, and the like. The control member may also be arranged to perform the same function with the background video signal. In addition, the control member may allow the user to choose only a desirable portion of the background video signal and superpose the selected portion onto the video signal. The control member may also be arranged to perform other conventional signal processing algorithms pertaining to the audio and/or video signals which are known to one of ordinary skill in the relevant art.

The system may include at least one switch for enabling the user to control various features of the signal superposition. In one example, the switch may operatively couple with the control and/or processing units of the control member in order to allow the user to directly initiate or stop such signal superposition by manipulating the switch. In another example, such a switch may operatively couple with the memory and/or control units of the control member and allow the user to select or retrieve the desired background signal from the memory unit by manipulating the switch. In another example, such a switch may operatively couple with the processing unit of the control member in order to allow such an user to adjust the amplitudes of the retrieved signal during the signal superposition. In yet another example, the switch may operatively couple with the output unit and play the retrieved, compound or outgoing signal to the user. In all of these examples, the switch may preferably be disposed in order to provide an easy access to the user, e.g., exposed through a portion of the body of the system.

As described herein, the receiving and/or transmitting members may receive and/or transmit at least one of such signals through wire or wirelessly. The above communication device may be and/or may function as a wireless mobile telephone, a cordless telephone having a handset and a base set, a conventional telephone receiving and sending said signals through wire, and the like. In addition, the signal superposing system of this invention may be incorporated into other devices such as various music playing device examples of which may include, but not be limited to, a tape player, a CD player, an MP3 player, and so on, each of which may be stationary or portable), and so on. Accordingly, the signal superposing systems of the present invention may also be incorporated into the above devices as separate module. Alternatively, the signal superposing system may be arranged to recruit at least one member and/or unit of such devices and utilize such as its receiving and/or transmitting members or as one of the units thereof.

At least one of such signals may be an audio signal, video signal, and/or audiovisual signal. In addition, at least one of such members and/or their units may receive, store, process, and/or transmit only audio signals, only video signals or audiovisual signals. More particularly, the background signal may be one of the incoming, input, and/or outgoing signals recorded in real time by the user using the system or device, one of such incoming, input, and/or outgoing signals prerecorded by the user using the system or device, a signal provided by a manufacturer of such a system or device, a signal which is provided through other electric or optical devices, and so on. The retrieved background signal may be at least one signal as is stored in the memory unit or at least one signal generated by manipulating at least one signal stored in such a memory unit. The background signal may also be a mute or silent signal, i.e., a signal without any content signal. In general, various background signals stored in the memory unit may not have identical lengths. Accordingly, the retrieved signals may not necessarily have the same length either, unless the memory or control unit may retrieve portions of such signals having the same or similar lengths.

The control member and/or unit may provide the selected background signal through retrieving at least one signal as stored in the memory unit or, in the alternative, by retrieving multiple signals and by manipulating at least one of such retrieved signals. The outgoing signal may be the input signal or a compound signal which may consist of the input signal superposed by the background signal.

As described above, the transmitting member may transmit the compound signal without any further manipulation and, therefore, the outgoing signal may become identical to the compound signal. Otherwise, such a transmitting member may vary one or more wave characteristics of the compound signal so that the compound signal may become different from the outgoing signal, where examples of the characteristics may include, but not be limited to, amplitudes, phase angles, number of harmonics, frequencies of such harmonics, and so on.

The control member may superpose the retrieved signal onto the input signal in various modes as well. For example, the control member may superpose only a (or an entire) portion of the retrieved signal onto only a (or an entire) portion of the input signal. The control member may rather superpose only a (or an entire) portion of the retrieved signal repeatedly onto only a (or an entire) portion of the input signal. In addition, the control member may superpose only (or entire) portions of at least two of the retrieved signals onto only a (or an entire) portion of the input signal in a preset order. Moreover, the control member may also superpose at least another background signal onto the compound signal while generating the outgoing signal. The control member may also manipulate the amplitudes of such retrieved, compound, and/or outgoing signals at least partly dependent on the amplitudes of the input signal. When desirable, such a control member may neither retrieve nor superpose any background signals onto the input signal, therefore, the outgoing signal may be similar or identical to such an input signal.

In another aspect of the present invention, a signal superposing system of this invention may be incorporated into a communication network which may consist of a communication provider and at least one communication device, where the communication provider may form a network of wireless and/or wired paths for various signals which are transmitted by and/or sent to an user and where the communication device may receive an incoming signal from a third party through the network and/or transmit an outgoing signal to the third party therethrough. Various members and/or units of the signal superposing system may then be distributed to one or both of the communication provider and device in various modes.

In one exemplary embodiment of this aspect of the present invention, a communication network may include the above communication provider and communication device, where all of the foregoing members and units of such a signal superposing system may be incorporated into the communication device. Therefore, such a system may be represented by any of FIGS. 1A to 2B, where its receiving, transmitting, and control members 20, 30, 40 may be identical to those of such figures and disposed similar to those embodiments of such figures. In addition, the incoming signal from the third party may be transmitted to the receiving member of the system or device through the network and the outgoing signal from the user may similarly be transmitted by the transmitting member of the user's device to the third party through the network. The communication provider may then be arranged to ensure proper reception and transmission of such signals through its network. It is appreciated in this embodiment that the communication provider may store multiple background signals which may be retrieved by the control member of the system or device and superposed onto the input signal therein.

In another exemplary embodiment of such an aspect of the present invention, a communication network may include the above communication provider and communication device, where as many members and/or units of such a system may be incorporated into the communication provider, while a bare minimum of the members and/or units of the system may be incorporated into the communication device. For example, such a communication device may include the receiving and output units of the receiving member as well as the input and transmitting units of the transmitting member, while all of the memory, control, and processing units of the control member may be provided into the communication provider. Therefore, such a device may receive the input signal and user command from the user and transmit to the provider both of the input signal and user command. The provider may retrieve at least one background signal from its memory unit based upon the user command, superpose the retrieved signal onto the input signal in order to generate a compound signal in its control and processing units, generate an outgoing signal at least in part from the compound signal, and then transmit the outgoing signal through its network. This embodiment offers the benefit of minimizing a volume and a weight of the communication device. It is appreciated that the provider of such an embodiment may also transmit the retrieved, compound, and/or outgoing signals to the device in order to allow the user to hear such signals.

In another exemplary embodiment of such an aspect of the present invention, a communication network may include the above communication provider and communication device, where only some members and/or units of the system may be incorporated into such a communication device, whereas its other members and/or units may be incorporated into the communication provider. In one example, the communication provider may include the memory unit, while the communication device may have the control and processing units. Such a device may receive the input signal and user command from the user and transmit to the provider only the user command. The provider may retrieve at least one background signal from its memory unit based upon the user command and send the retrieved signal to the device which may then superpose the retrieved signal onto the input signal in order to generate a compound signal in its control and processing units, generate an outgoing signal at least in part from the compound signal, and transmit the outgoing signal through the network to the provider which may transmit the outgoing signal to the third party through the network. In another example, the provider may include the processing unit, while the device may include the memory and control units. Such a device may receive the input signal and user command from its user, retrieve at least one background signal from its memory unit, and transmit both of the input and retrieved signals to the provider through the network. Thereafter, the provider may superpose the retrieved signal onto the input signal so as to form the compound signal, generate the outgoing signal at least in part from the compound signal, and transmit the outgoing signal to the third party through its network. When desirable, the provider may transmit the retrieved, compound, and/or outgoing signals to the device in order to allow the user to hear such signals. This embodiment offers the benefit of reducing the volume and/or weight of the communication device.

In another exemplary embodiment of such an aspect of the present invention, a communication network may also include the communication provider and communication device, where the provider may include a memory unit therein. Other units of the control member may then be distributed only into the communication device, only into the communication provider or into both the communication device and provider. It is appreciated that the memory member of the provider may specifically be arranged to acquire various background signals in real time. In one example, the device may include the control and processing units, where such a device may receive the input signal and user command, transmit the user command to the provider, retrieve one or more real-time background signals from the memory unit based on the user command, superpose the retrieved signal onto the input signal in order to form the compound signal, generate the outgoing signal at least in part from the compound signal, and then transmit the outgoing signal to the provider. In another example, the provider may include the control and processing units, where the device may receive the input signal and user command and transmit such to the provider, and where the provider may retrieve at least one real-time background signal from its memory unit based on the user command, superpose the retrieved signal onto the input signal in order to form the compound signal, generate the outgoing signal at least in part from the compound signal, and transmit the outgoing signal through its network. In another example, the control unit may be disposed in one of the communication provider and device, whereas the processing unit may be disposed in the other of the provider and device, where operational procedures are similar or identical to those described hereinabove.

It is understood in all of such examples that the compound (or outgoing) signal may include the real-time input signal superposed with another real-time retrieved signal and, therefore, that such a compound (or outgoing) signal may give the third party a better impression that the user is currently involved in a preset event and/or residing in a preset location, either of which may be connoted by the retrieved signal. To this end, such a communication provider is preferably arranged to include multiple input units which are disposed in preset landmarks for the purpose of acquiring real-time background signals associated with preset events and/or such signals obtainable in preset locations.

Configurational and/or operational variations and/or modifications of the foregoing exemplary communication networks, communication providers, and/or communication devices described above also fall within the scope of this invention.

The provider may be arranged to transmit the outgoing signal through its network without any modification. Alternatively, the provider may modify at least a portion of the outgoing signal and then transmit such a modified outgoing signal through said network. The retrieved background signal may be prerecorded and stored in the provider. In the alternative, the retrieved background signal may be provided by the provider in real time along with the input signal. More specifically, the retrieved signal may be provided by the provider in real time in a location in which the user is not located, in an event in which the user is not involved, and so on.

The processing unit may manipulate an amplitude of the retrieved signal in such superposing. The processing unit may to manipulate a ratio of an amplitude of the retrieved signal to that of the input signal during the superposing. The processing unit may also manipulate an amplitude of the retrieved signal in a preset temporal pattern during said superposing. The processing unit may also manipulate an amplitude of the retrieved signal during such superposing adaptively with respect to an amplitude of the input signal based upon the user command.

The background signals may have preset lengths, where the processing unit may generate the compound signal by repeating such superposing until the input signal which is longer than the preset length of the retrieved signal terminates. The background signals may have preset lengths, where the processing unit may generate the compound signal by performing such superposing of at least two of the retrieved background signals according to a preset order until the input signal which is longer than a sum of the preset lengths of such at least two of the retrieved signals terminates. Alternatively, the background signals may have preset lengths, while the processing unit may generate the compound signal by superposing one of at least two of such retrieved background signals in a preset order and to continue such superposing in a different order until the input signal which is longer than a sum of the preset lengths of such at least two of the retrieved signals terminates.

Other configurational and/or operational characteristics of such signal superposing systems described in conjunction with FIGS. 1A to 2B may also apply to various members and/or units of such communication networks, communication providers, and communication devices.

Unless otherwise specified, various features of one embodiment of one aspect of the present invention may apply interchangeably to other embodiments of the same aspect of this invention and/or embodiments of one or more of other aspects of this invention.

Although a few exemplary embodiments of the present invention have been described, those skilled in the relevant art will readily appreciate that many modifications are possible in the exemplary embodiments without materially departing from the novel teachings and advantages of this invention. Accordingly, all such modifications are intended to be included within the scope the present invention as defined in the following claims.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A signal superposing system for a portable communication device which includes a receiving member capable of receiving an incoming signal and a transmitting member capable of receiving an input signal generated by an user and transmitting an outgoing signal, at least a portion of said system incorporated into said device and said system comprising:
at least one memory unit configured to store therein a plurality of background signals;
at least one control unit configured to receive at least one user command and to retrieve from said memory unit at least one of said background signals based on said user command; and
at least one processing unit configured to generate a compound signal by superposing said retrieved signal over said input signal, and to send said compound signal to said transmitting member capable of generating said outgoing signal at least in part from said compound signal and transmitting said outgoing signal in real time.

2. The system of claim 1, wherein said processing unit is configured to manipulate an amplitude of said retrieved signal during said superposing.

3. The system of claim 1, wherein said processing unit is further configured to control a ratio of an amplitude of said retrieved signal to that of said input signal during said superposing.

4. The system of claim 1, wherein said processing unit is further configured control an amplitude of said retrieved signal in a preset temporal pattern during said superposing.

5. The system of claim 1, wherein said processing unit is further configured to manipulate an amplitude of said retrieved signal during said superposing adaptively with respect to an amplitude of said input signal.

6. The system of claim 1, wherein said retrieved signal defines a preset length and wherein said processing unit is configured to generate said compound signal by repeating said superposing till said input signal which is longer than said preset length terminates.

7. The system of claim 1, wherein said control unit is configured to retrieve at least two of said background signals having preset lengths and wherein said processing unit is configured to generate said compound signal by repeating said superposing until said input signal which is longer than a sum of said preset lengths of said at least two of said retrieved signals terminates.

8. The system of claim 1, wherein said control unit is configured to retrieve at least two of said background signals having preset lengths and wherein said processing unit is configured to generate said compound signal by superposing said at least two of said retrieved background signals over said input signal in one preset order in real time and to repeatedly continue said superposing in a different order until said input signal which is longer than a sum of said preset lengths of said at least two of said retrieved signals terminates.

9. The system of claim 1, wherein at least one of said signals is configured to be one of an audio signal, a video signal, and an audiovisual signal.

10. The system of claim 1 which is configured to acquire at least one of said background signals from at least a portion of at least one of said incoming signal, input signal, and outgoing signals.

11. The system of claim 1 which is configured to provide at least one of said background signals by appending at least two of the rest of said background signals.

12. The system of claim 1 which is configured to provide at least one of said background signals by repeating one of said background signals for a preset number of times.

13. The system of claim 1. wherein at least one of said background signals is one of acquired in real time, prerecorded, and provided by a manufacturer of said system.

14. The system of claim 1 which is configured to acquire at least one of said background signals from an external storage device including one of a magnetic tape, magnetic disk, a microchip, a DVD, and a CD, each capable of storing therein one of analog and digital signals.

15. The system of claim 1, wherein at least one of said background signals may be a noise signal.

16. The system of claim 1 which is configured to allow said user to play and to hear at least one of said background signals before said superposing.

17. The system of claim 1 which is configured to allow said user to play and to hear said retrieved signal during said superposing.

18. The system of claim 1 which is configured to allow said user to play and hear said compound signal during said superposing.

19. A communication network for allowing an user to receive an incoming signal and to transmit an outgoing signal therethrough while superposing at least one background signal selected by said user onto an input signal from said user comprising:
a communication provider which is configured to provide said network defining at least one of wireless and wired paths for a plurality of signals sent to and received from said user;
a communication device which is configured to receive said input signal from said user and to transmit said outgoing signal to said provider;
at least one memory unit which is incorporated into said device and configured to store therein a plurality of background signals;
at least one control unit which is incorporated in said device and configured to receive at least one user command and then to retrieve at least one of said background signals based upon said user command from said memory unit;
at least one processing unit which is incorporated into said device and configured to generate a compound signal by superposing said retrieved signal over said input signal in real time; and
at least one transmitting unit which is incorporated into said device and configured to generate said outgoing signal at least in part from said compound signal and to send said outgoing signal to said provider.

20. A communication network for allowing an user to receive an incoming signal and to transmit an outgoing signal therethrough while superposing at least one background signal selected by said user onto an input signal from said user comprising:
a communication provider which is configured to provide a network of at least one of wireless and wired paths for a plurality of signals sent to and received from an user and to have a processing unit capable of superposing one signal over another signal;
a communication device which is configured to receive at least one input signal from said user and to transmit an outgoing signal to said provider; and
a signal superposing system which is incorporated into said device and configured to store a plurality of background signals, to receive at least one user command, to retrieve at least one of said background signals based upon said user command, and to send said retrieved signal to said device,
wherein said device is configured to transmit said input signal and said retrieved signal to said provider which is configured to generate a compound signal by superposing said retrieved signal over said input signal in its processing unit, to generate said outgoing signal at least in part based upon said compound signal, and to then transmit said outgoing signal through said network.
